(19) United States
(12) Patent Application Publication
(10) Pub. No.: US 2026/0367808 A1
(43) Pub. Date: Nov. 19, 2026

(54) Efficient Compare Command Execution Using Encryption

(71) Applicant: Sandisk Technologies, Inc., Milpitas, CA (US)

(72) Inventors: Amir SEGEV, Meiter (IL); Shay BENISTY, Beer Sheva (IL); Inbal MODAN, Meiter (IL)

(73) Assignee: Sandisk Technologies, Inc., Milpitas, CA (US)

(21) Appl. No.: 19/209,967

(22) Filed: May 16, 2025

(51) Int. Cl. G06F 3/06

(52) U.S. Cl. CPC G06F 3/0623; G06F 3/0611; G06F 3/0659; G06F 3/0679

(57) ABSTRACT

For compare commands, rather than decrypting data fetched from the memory device and comparing the decrypted data to not encrypted user data from the host device, the compare may occur with encrypted data. By comparing encrypted data, less memory is needed in the controller because memory is not needed to hold decrypted data from the memory device. Encrypted user data may be stored in the already existing temporary storage that stores the fetched, encrypted data from the memory device. Even if the protection information (PI) of the user data is incorrect, the compare command can be processed by using PI from the first LBA fetched from the memory device for the compare command. The first LBA is decrypted, the PI is extracted, and the extracted PI is inserted into the PI fields of the user data, which is then encrypted. The comparison then proceeds with encrypted data.

### BACKGROUND OF THE DISCLOSURE

### Field of the Disclosure

Embodiments of the present disclosure generally relate to optimizing compare command execution.

### Description of the Related Art

A nonvolatile memory (NVM) express (NVMe) compare command is used to compare data that is stored in a memory device to data provided by a host device. Broadly speaking, to execute the compare command, data is read from the memory device and compared to data provided by the host device.

The data in the memory device is typically encrypted while the data from the host device is typically not encrypted. Thus, a direct comparison is not possible because comparing encrypted data to not encrypted data will not be accurate. Therefore, the data read from the memory device is decrypted, and the now decrypted data read from the memory device is compared to the not encrypted data from the host device. If the data matches, then the compare command succeeds, and the host is notified. If the data does not match, then the compare command fails, and the host is notified.

Decrypting the data read from the memory device involves utilizing data storage device resources, and may not be efficient. Therefore, there is a need in the art for optimizing compare command execution.

### SUMMARY OF THE DISCLOSURE

For compare commands, rather than decrypting data fetched from the memory device and comparing the decrypted data to not encrypted user data from the host device, the compare may occur with encrypted data. By comparing encrypted data, less memory is needed in the controller because memory is not needed to hold decrypted data from the memory device. Encrypted user data may be stored in the already existing temporary storage that stores the fetched, encrypted data from the memory device. Even if the protection information (PI) of the user data is incorrect, the compare command can be processed by using PI from the first LBA fetched from the memory device for the compare command. The first LBA is decrypted, the PI is extracted, and the extracted PI is inserted into the PI fields of the user data, which is then encrypted. The comparison then proceeds with encrypted data.

In one embodiment, a data storage device comprises: a memory device; and a controller coupled to the memory device, wherein the controller is configured to: receive a compare command; fetch encrypted data from the memory device, wherein the encrypted data is for the compare command; fetch not encrypted data from a host device, wherein the not encrypted data is for the compare command; encrypt the not encrypted data fetched from the host device; and compare the encrypted data fetched from the memory device and the encrypted data fetched from the host device.

In another embodiment, a data storage device comprises: a memory device; and a controller coupled to the memory device, wherein the controller is configured to: receive a compare command; determine whether the compare command has protection information (PI) metadata; determine whether one or more PRCHK fields equal 0; fetch a first logical block address (LBA) from the memory device; decrypt the first LBA; extract PI from the decrypted first LBA and insert the extracted PI into PI fields of user data fetched from a host device; and execute the compare command using encrypted data.

In another embodiment, a data storage device comprises: means for storing data; and a controller coupled to the means for storing data, wherein the controller is configured to: determine a workload of one or more of a decryption module and an encryption module; decide to execute compare commands using decrypted data or encrypted data based upon the determining; and execute compare commands based upon the deciding, wherein the determining and deciding are repeated.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of a read/write system according to one embodiment.

FIG. 3 is a schematic illustration of a read/write system according to another embodiment.

FIG. 4 is a schematic illustration of a storage tag and reference tag location in a command according to one embodiment.

FIG. 5 is a flowchart illustrating compare command processing according to one embodiment.

FIG. 6 is a flowchart illustrating compare command processing according to another embodiment.

FIG. 7 is a flowchart illustrating compare command processing according to another embodiment.

FIG. 8 is a flowchart illustrating compare command processing according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

For compare commands, rather than decrypting data fetched from the memory device and comparing the decrypted data to not encrypted user data from the host device, the compare may occur with encrypted data. By comparing encrypted data, less memory is needed in the controller because memory is not needed to hold decrypted data from the memory device. Encrypted user data may be stored in the already existing temporary storage that stores the fetched, encrypted data from the memory device. Even if the protection information (PI) of the user data is incorrect, the compare command can be processed by using PI from the first LBA fetched from the memory device for the compare command. The first LBA is decrypted, the PI is extracted, and the extracted PI is inserted into the PI fields of the user data, which is then encrypted. The comparison then proceeds with encrypted data.

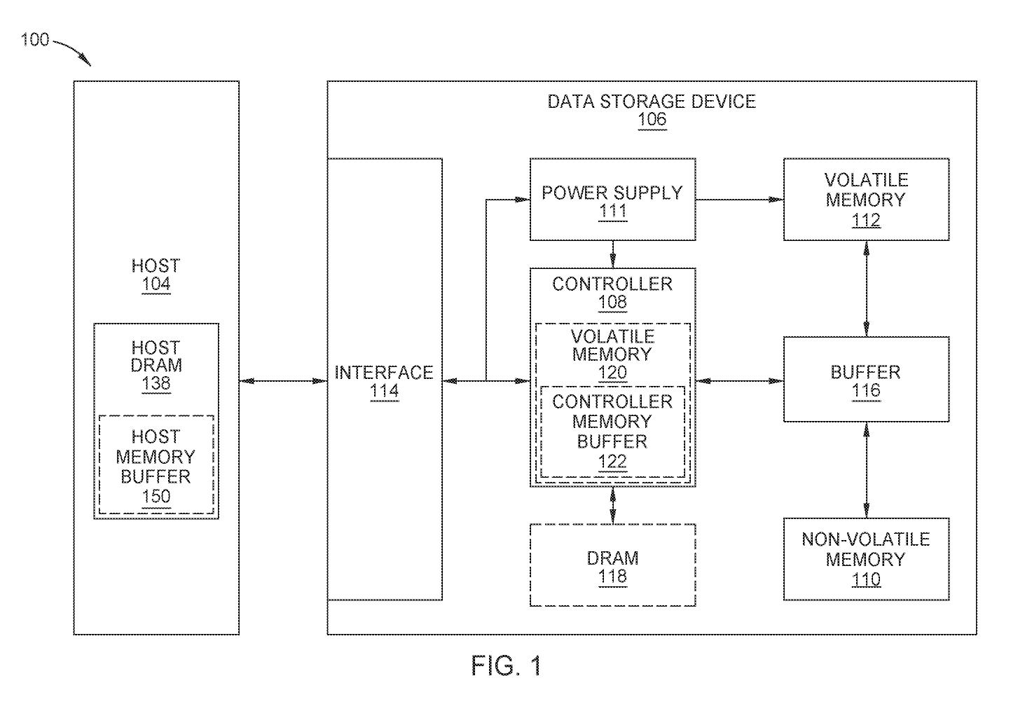

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

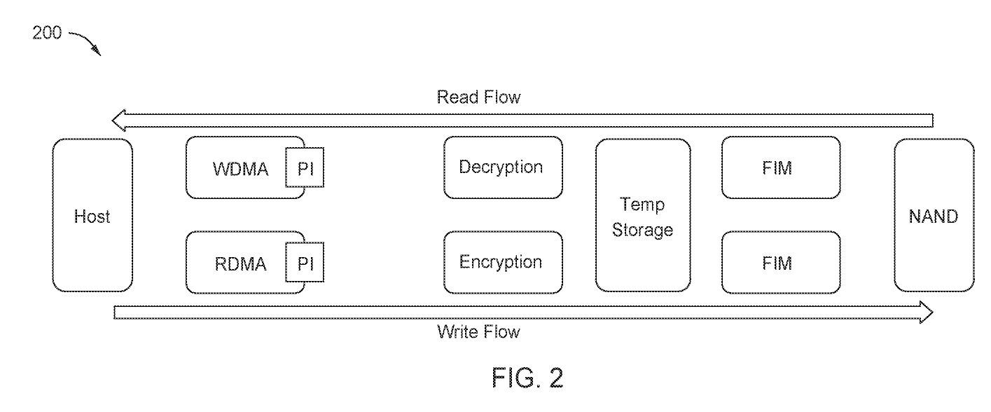

FIG. 2 is a schematic illustration 200 of a read/write system according to one embodiment. The system includes a host device and a memory device (e.g., NAND). The read flow comprises a controller between the host device and the memory device where the controller includes a direct memory access (DMA) module for writes (WDMA), a decryption module, a temporary storage, and a flash interface module (FIM). The write flow comprises a controller between the host device and the memory device where the controller includes a read DMA (RDMA), an encryption module, the temporary storage, and a FIM. NVMe compare commands require the following basic steps: fetch data from the host device; read data from the memory device (e.g., NAND); and compare the data. Thus, there are two basic steps, Step A and Step B. For Step A, fetching the data is in most ways identical to “write flow”. For Step B. reading the data from the memory device (e.g., NAND) is in most ways identical to “read flow”.

In a normal read flow, data is read from the memory device (e.g., NAND) by the FIM. The data is than stored in a temporary buffer (i.e., Temp Storage in FIG. 2) such as SRAM or DRAM. From there, the data goes through decryption using an AES-XTS engine as example where the WDMA checks the NVMe-metadata protection information (PI) and writes the data to the host device.

In a normal write flow, the data works in the opposite way to the normal read flow. The RDMA triggers the PI generation and check, moves the data through an encryption engine to temporary storage, and then the FIM takes the data and writes the data in the memory device (e.g., NAND).

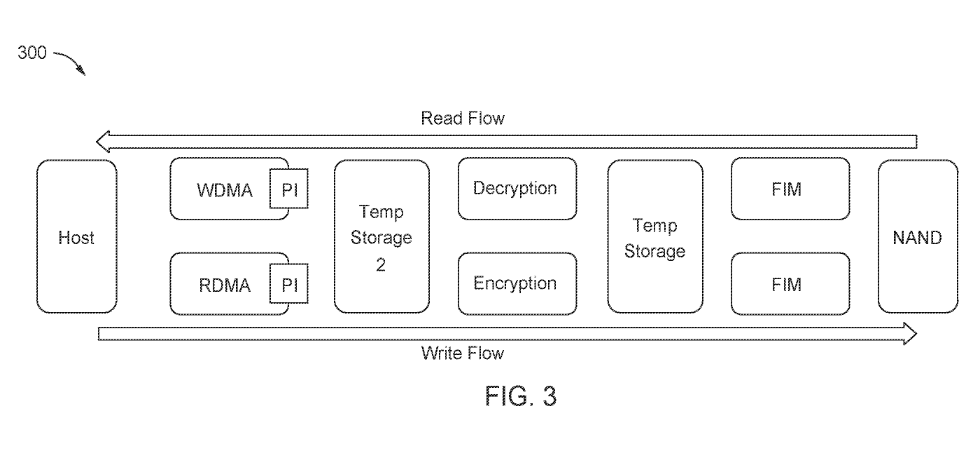

FIG. 3 is a schematic illustration 300 of a read/write system according to another embodiment. The system is similar to FIG. 2 except for the addition of a second temporary storage, Temp Storage 2. For compare commands it is expected that “step A” and “step B” stops at Temp Storage 2, where the data is not encrypted. Stopping at Temp Storage 2 allows comparing the data at “step C”. Having a second temporary storage in the data path complicates the implementation and the normal read/write flow. In particular, memory is expensive, and adding in an additional, temporary storage increases the cost of the data storage device. Thus, to be able to execute compare commands using decrypted data, the Temp Storage 2 is present. The additional storage, Temp Storage 2, is costly.

It is conceivable to compare in an ‘exception flow’ where data is handled (out of the performance path) one LBA at a time. However, performing a compare in an ‘exception flow’ significantly impacts the performance of the compare command. Additionally, if the decryption engine is shared between performance flow, and exception flow, then the sharing will cause bubbles in the performance flow.

Circling back to the basics, the basic idea for the compare command is that the data storage device needs to fetch data from the host device and fetch data from the memory device (e.g., NAND) and compare the fetched data. In write command flow, data read from the host device is ultimately encrypted and then written to the memory device. In read command flow, data is read from the memory device, decrypted, and sent to the host device.

One way to do a compare command is to read from the host device and stop at Temp Storage 2 without doing encryption. Similarly read from the memory device and at Temp Storage 2 doing only the decryption and then comparing the non-encrypted data. Temp Storage 2 complicates the data because while executing the compare command, other data cannot be moved. Thus, Temp Storage 2 complicates the flow, as well as increases costs by merely existing. The idea is to do the comparison on the encrypted data at Temp Storage, which is random allocation data, big data, a big memory, etc. The disclosure involves doing the comparison on the encrypted data. The problem with comparing encrypted data is the PI information. If stopping at the Temp Storage, the data storage device can compare correctly only if the PI is correct in the encrypted data.

Generally speaking, the data storage device does not need to compare the PI, only to check it’s correctness on the memory device, however it cannot be done in encrypted data because once encrypted everything is one big mess of data. The PI still needs to be dealt with so instead of comparing part of the metadata, the data storage device still need to check the PI on the memory device (e.g., NAND). Maybe not all of PI, but the data storage device needs to read metadata as it appears on the memory device (e.g., NAND) and check the PI. The idea here is that the data storage device will generate, just like always, the correct PI. So the flow will continue normally until reaching the Temp Storage. For the compare command, the data storage device will generate correct PI and then when reading from the memory device (e.g., NAND), the data storage device will read the correct PI and compare the PI. Comparing the PI is part of the compare command, even if the PI comes out wrong from the host device. To generate the correct PI, the data storage device needs to have correct fields in the command itself. When the host device tells the data storage device to not compare or check the metadata, the host device might decide to not provide the correct PI in the command.

The disclosure suggests doing the comparison at the original Temp storage, which would be encrypted data. The disclosure also provides a solution on how handle the PI metadata.

The compare command adds two “complexity levels”: (A) do not compare the PI (part of the NVMe metadata); and (B) selectively check correctness of some of the PI as the PI appears in the memory device (e.g., NAND).

The basic idea is to do flow-A (read from host device) up to the Temp Storage (i.e., DRAM) after encryption. Also, do flow-B (read from memory device) up to the Temp Storage (i.e., DRAM) before decryption. Thereafter, the data is compared.

The first complexity is no PI comparison. Since the data storage device does not need to compare the PI, the data storage device might receive incorrect PI from the host device. After data encryption, the data storage device cannot selectively compare only the non-PI bytes. For simple write commands with PRACT=0, the host device transfers the wrong PI as well, or not transfer the PI at all. As such, the WDMA has the capability of generating (and overwriting) PI information for data arriving from the host device.

The device PI module needs to support generation/replacement of PI. In particular, for bit 03, PI action (PRACT) is that the bit specifies the action to take for the PI. If the namespace is not formatted to use end-to-end PI, then the bit shall be ignored by the controller. For a PRACT value of 1b and a 8B PI format for metadata size 8B, and 16B PI format for metadata size 16B, the PI is stripped (read) or inserted (write). For a PRACT value of 1b and a 8B PI format for metadata size >8B, and 16B PI format for metadata size >16B, the PI is passed (read) or replaces the PI in the metadata (write). For a PRACT value of 01b and a 8B PI format for metadata of any size, and 16B PI format for metadata of any size, the PI is passed (read and write). By using the functionality on the “read from host part” of the compare command. The data storage device again has corrected PI, and again can compare the encrypted data.

The second “complexity” is selectively checking the correctness of PI. The host device can select which fields in the PI (there are four: APPTAG, REFTAG, STORAGE_TAG and GUARD) needs to be checked. The storage tag check definition is that the PI check (PRCHK) field specifies the fields that shall be checked as part of end-to-end data protection processing. If the namespace is not formatted to use end-to-end PI, then the field shall be ignored by the controller. For bit 02, guard check involves if the guard is set to “1” enabling PI checking of the guard field, but if cleared to “0”, the guard field is not checked. For bit 01, for the application tag check, if the application tag is set to “1”, PI checking of the application tag field is enabled, but if cleared to “0”, the application tag field is not checked.

For bit 00, for the reference tag check, if the reference tag is set to “1”, it enables PI checking of the logical block reference tag field, but if cleared to “0”, the logical block reference tag field is not checked. For storage tag check, bit 00, the bit specifies the checking requirements for the storage tag field, if defined. If set to “1”, then PI checking of the storage tag field is enabled. If cleared to “0”, the storage tag field is not checked. If the storage tag size (STS) field is cleared to 0h, then the bit shall be ignored by the controller as no storage tag field is defined.

If the host device wants the device to check the APPTAG, the host device needs to transfer the correct APPTAG in the command itself. The same applies tor REFTAG and STORAGE_TAG. The application tag (APPTAG) in a command example involves using the expected logical block application tag (ELBAT) which field specifies the application tag expected value. If the namespace is not formatted to use end-to-end PI, then this field is ignored by the controller.

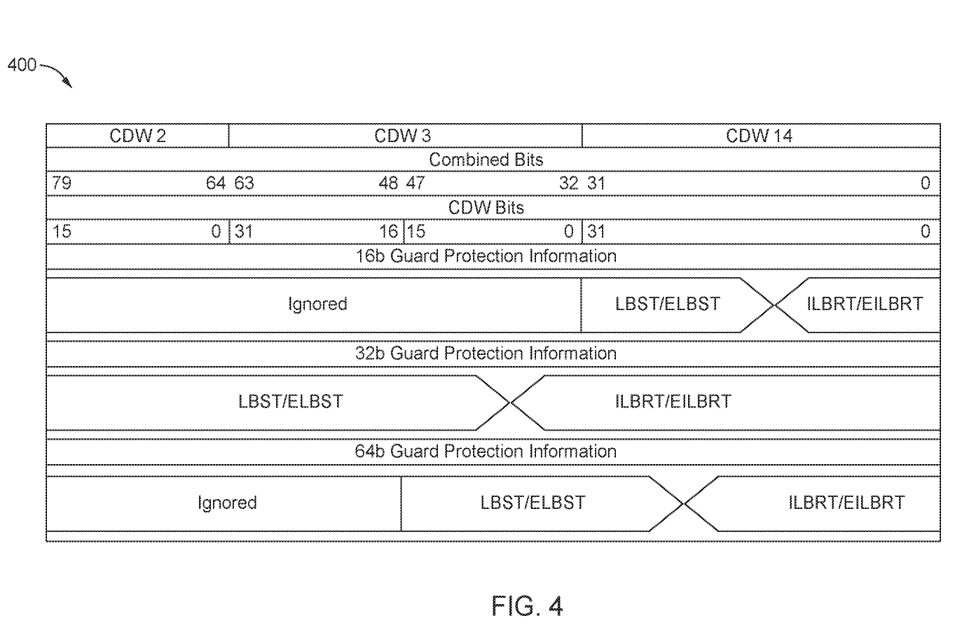

FIG. 4 is a schematic illustration 400 of a storage tag and reference tag location in a command according to one embodiment. If the host device can select to NOT check APPTAG as noted above, than it means the host device can provide the wrong ELBAT field discussed above or the wrong STORAGE_TAG or REF_TAG discussed above and appearing in Dword (DW) 2, 3, and 14 of the command shown in FIG. 4. As a result, the data storage device will not produce correct PI data, and the encrypted data will not be comparable again.

In case any of the fields is marked for not checking, the data storage device will perform an “exception flow” on the first LBA of the command, which means the data storage device will read that LBA from the memory device (e.g., NAND), decrypt the LBA using the non-performance path (i.e., single FMU, not the entire command), and extract from there the “correct” ELBAT or information required for the other PI fields. Then, the data storage device will “update” the original compare command with the correct information and run the “normal secure compare flow”.

Regardless of the above, in one embodiment, the PI provided by the host device is ignored or assumed to be incorrect. In such a situation, the PI will be replaced regardless of whether the PI is correct. Additionally, the PI will not be checked for correctness. The PI will simply be replaced.

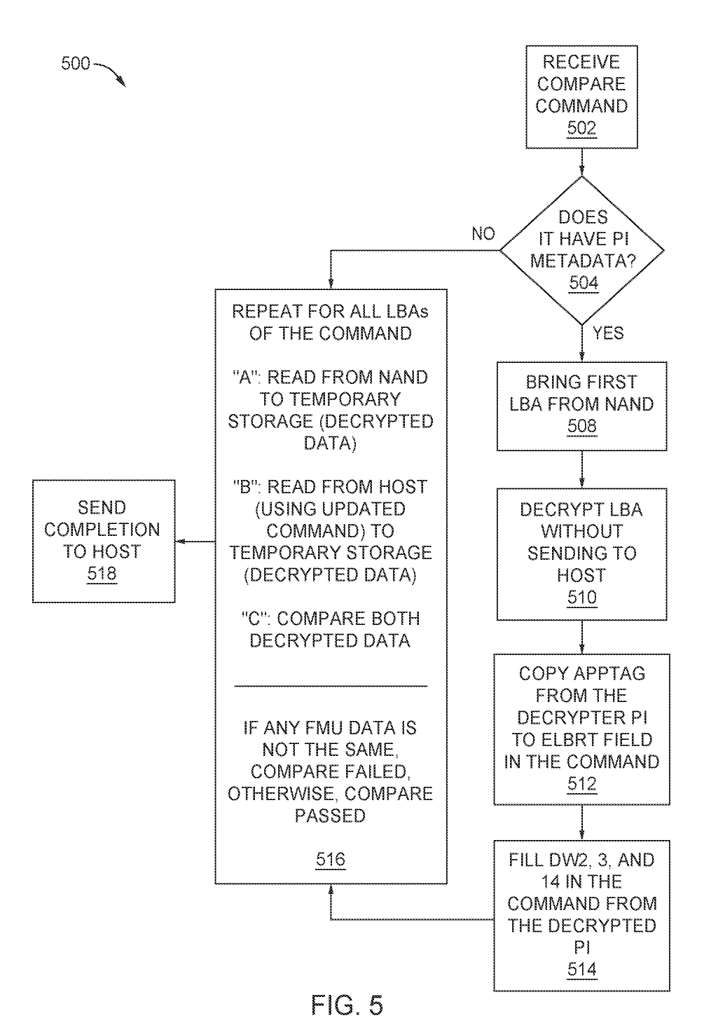

FIG. 5 is a flowchart 500 illustrating compare command processing according to one embodiment. Generally speaking, if the data storage device doesn’t need to check, as there is no PI (504), then all the checks are disabled and the process proceeds with the flow on the left (i.e., block 516). Otherwise, the data storage device only does the first LBA. The data storage device takes only the first LBA from the memory device (e.g., NAND), not of the all the command. The data storage device decrypts the first LBA to obtain the correct information. The data storage device then queues the correct information in the copy command, overrides the dummy information with the correct information, and then proceeds to the flow on the left (i.e., block 516). So in the flow on the left (i.e., block 516), the data storage device is going FMU by FMU or LBA by LBA, and reads from the memory device (e.g., NAND). The data storage device also reads data from the host device, with the correct items, and then the compares the data. Depending upon the results of the comparison, the appropriate completion to the host device. On the right column is illustrated the flow described under “second complexity solution”. In the middle the full “automated” flow is illustrated. On the left, the flow is finished by sending a completion (passed or failed) to the host device.

More specifically with regards to the flowchart 500, the process begins with the data storage device receiving a compare command at block 502. The data storage device then determines at block 504 whether the compare command has PI metadata. If there is no PI metadata, then the controller read and decrypts data from the memory device to temporary storage; reads non-encrypted data from the host device to temporary storage; and compares decrypted and non-encrypted data at block 516. If any FMU data is not the same, then the comparison fails. Otherwise, the compare passes. In either case, a completion is then sent to the host device at block 518.

If there is PI metadata at block 504, then the first LBA is obtained from the memory device (e.g., NAND) at block 508 followed by decrypting the LBA without sending the decrypted LBA to the host device at block 510 and stripping the PI therefrom. Then, the APPTAG is copied from the decrypted PI to ELBRT field in the compare command at block 512. Then, DW2, DW3, and DW 14 in the compare command are filled in from the decrypted PI at block 514 followed by proceeding to block 516 where the read from the host device will use the now updated command.

Stated another way, not only can the data storage device compare encrypted data instead of decrypted data (thus potentially eliminating the need for Temp Storage 2), the data storage device can accomplish the comparison with incorrect PI from the host device. If there is PI metadata, then the PI from the encrypted fetched data from the memory device can replace the incorrect PI from the host device so that the comparison can occur on encrypted user data from the host device (which includes corrected PI), and encrypted data fetched from the memory device. The PI from the memory device is decrypted and then added to the user data fetched from the host and then encrypted. Basically, once the PI from the memory device replaces the PI from the host device, encryption occurs and then the comparison occurs. Thus, for block 516, if the comparison occurs with decrypted data, A, B, and C occur. If the comparison occurs with encrypted data, then A does not include decryption, B is encrypted, and C compares encrypted data.

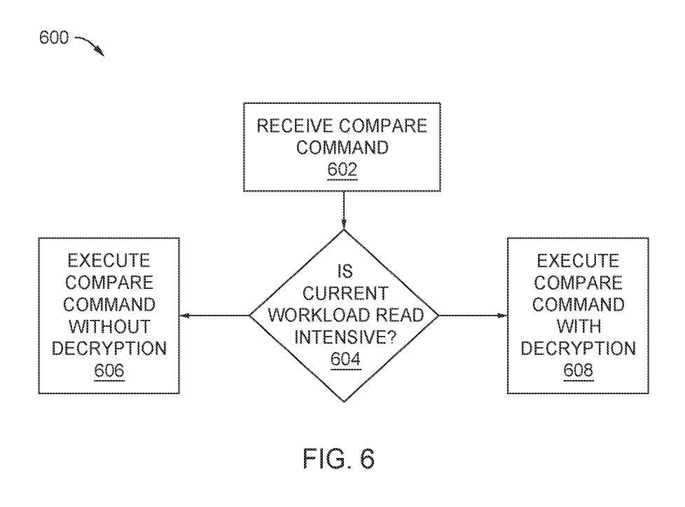

FIG. 6 is a flowchart 600 illustrating compare command processing according to another embodiment. In one embodiment, device controller may decide dynamically when to do the comparison (i.e., do the comparison on user-data or on encrypted data). The decision where to do the decision in the internal pipeline depends on the current workload of the device controller. For example, if the device controller is currently busy with random or sequential read operations, the decryption module is stressed and it would be better to activate the encryption logic for the compare commands and do the comparison on encrypted data so the decryption module will not be utilized by the compare command. If the device controller is currently busy with random or sequential write operations, the encryption module is stressed and it would be better to activate the decryption logic for the compare commands and do the comparison on raw user data so the encryption module will not be utilized by the compare command.

Considering FIG. 3 where there is both Temp Storage and Temp Storage 2, if there are a lot of write commands, the data storage device might want to decide to not waste the encryption engine time because the read flow is relatively not occupied. Thus, the controller might decide to do the decryption and then save the encryption module from working on the compare command to leave the encryption module for two write commands. If there are a lot of read commands, the decryption module should be heavily utilized. Due to the heavy usage of the decryption module, the controller does not want to use the compare command with the decryption. Instead, the controller will do the compare command in the original Temp Storage and the host device will do the encryption. In other words, the data storage device does not always have to do the comparison encrypted or even not encrypted. The controller can decide, based on the workload, whether to use the decryption and encryption modules for other tasks.

In regards to FIG. 6, the compare command is received at block 602 followed by a determination regarding whether the workload is read intensive at block 604. If the current workload is read intensive, then the compare command is executed without using the decryption module at block 606 using encrypted data. However, if the current workload is not read intensive, then the compare command is executed using the decryption module at block 608 using not encrypted data. In other words, block 606 performs the comparison at Temp Storage and block 608 performs the comparison at Temp Storage 2 from FIG. 3. Stated another way, it is contemplated that both Temp Storage 2 and Temp Storage may be present so as to take into consideration workflow. If workload is not taken into consideration, then Temp Storage 2 is not needed and may be excluded.

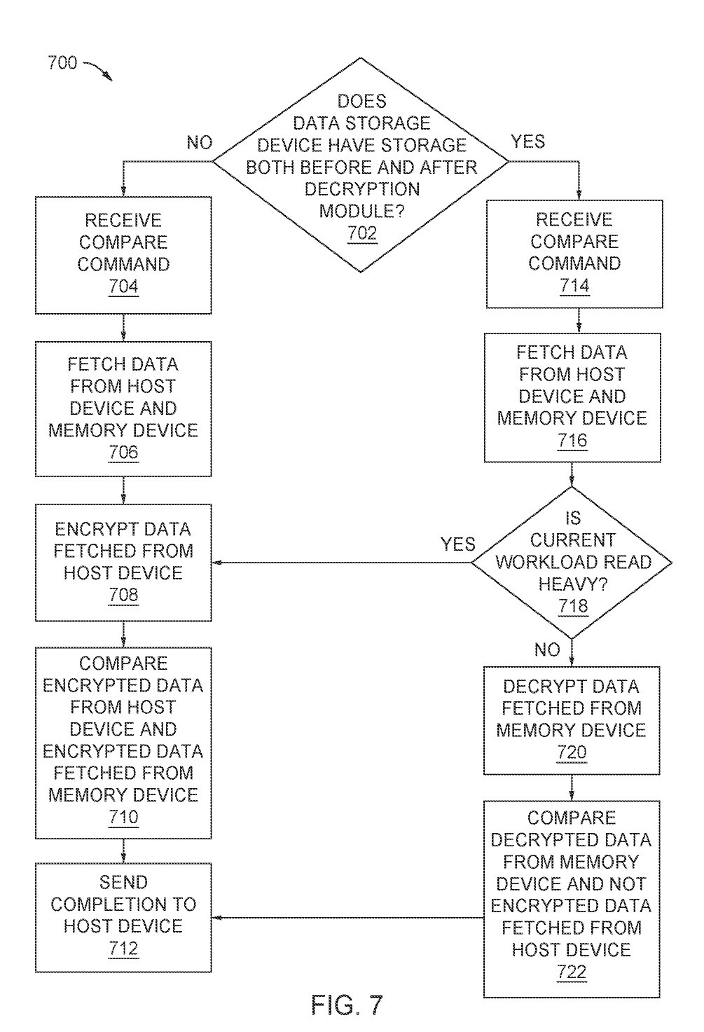

FIG. 7 is a flowchart 700 illustrating compare command processing according to another embodiment. Initially, a determination is made regarding whether the data storage device has storage at locations both before and after the decryption module at block 702. If there is not storage both before and after the decryption module, then when the data storage device receives a compare command at block 704, the controller will fetch data from both the host device and the memory device at block 706 followed by encrypting the fetched data from the host device at block 708. The comparison of the now encrypted host data and fetched memory device data (which is encrypted) will occur at block 710 followed by a completion being sent to the host device at block 712.

If there is storage both before and after the decryption module, then when the data storage device receives a compare command at block 714, the controller will fetch data from both the host device and the memory device at block 716 followed by determining whether the data storage device is currently experiencing a read heavy workload at block 718. If there is a read heavy workload, then the process may proceed to block 708. However, if there is not a read heavy workload, then the process proceeds by decrypting the fetched data from the memory device at block 720. The comparison of the now decrypted memory device data and fetched host device data (which is not encrypted and thus is user data) will occur at block 722 followed by a completion being sent to the host device at block 712.

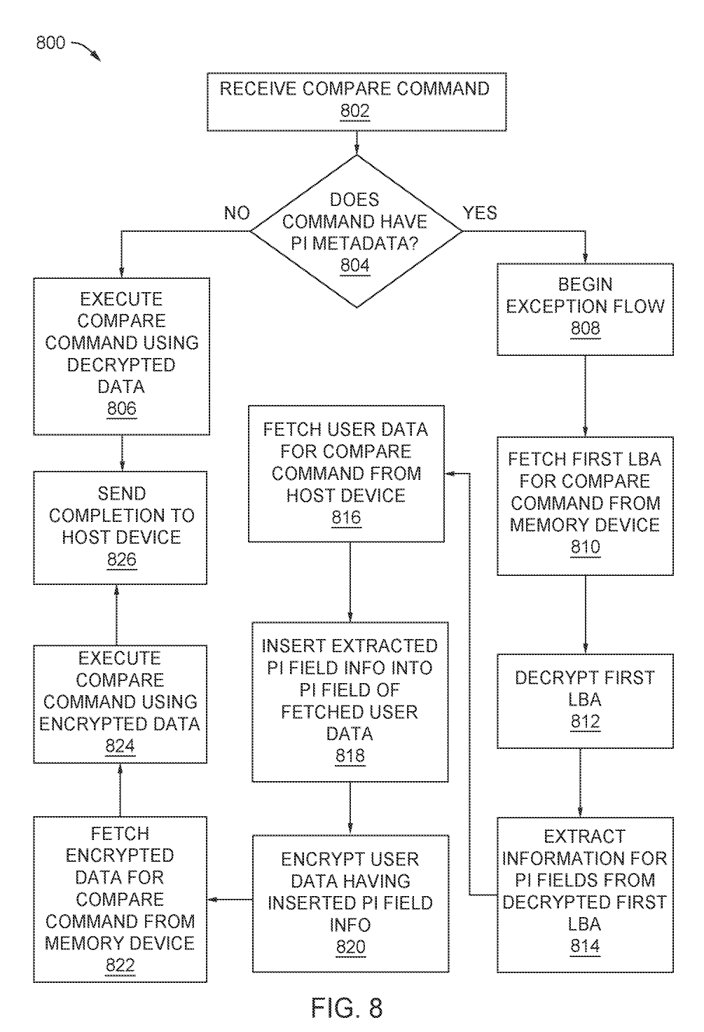

FIG. 8 is a flowchart 800 illustrating compare command processing according to another embodiment. To begin the process, a compare command is received at block 802 and a determination is made at block 804 regarding whether the compare command has PI metadata. If there are no fields marked for not checking, then the compare command can be executed using decrypted data at block 806, and then a completion can be sent to the host device at block 826. It is contemplated that even if there are no fields marked for not checking, the compare command can be executed on encrypted data, but if there is incorrect PI in the user data, then the compare command will fail before any actual comparison of the user data to data fetched from the memory device. What will be discussed below is how to handle the situation where the PI with the user data is irrelevant.

If there is no PI metadata with the command at block 804, then the PI for the user data is irrelevant and the exception flow begins at block 808. The first LBA for the compare command is fetched from the memory device at block 810 and then decrypted at block 812. It is important to note that only the first LBA is fetched and decrypted, however, it is contemplated that all LBAs can fetched, but only the first LBA will be decrypted.

Thereafter, information for the PI fields from the decrypted first LBA are then extracted at block 814. The user data is fetched for the compare command from the host device at block 816. It is to be understood that fetching the user data and fetching the first LBA (or all LBA) may occur simultaneously or in any order to optimize efficiency. In any event, once the user data is fetched and the information from the PI fields from the decrypted first LBA are available, the extracted information for PI fields from the decrypted first LBA is inserted into the PI fields of the fetched user data at block 818. The user data having the inserted information for PI fields from the decrypted first LBA is then encrypted at block 820. If all the LBAs for the compare command have not already been fetched from the memory device, the LBAs are then fetched at block 822.

The fetched LBAs from the memory device are not decrypted, other than the first LBA as mentioned above. The compare command is executed by comparing the fetched, encrypted LBAs from the memory device to the encrypted user data (which contains the inserted information in the PI fields from the decrypted first LBA from the memory device) at block 824. Thereafter, the completion is sent to the host device at block 826.

As noted above, the disclosure suggests doing a comparison on the encrypted data. The disclosure further suggests a solution when the encrypted data might be inaccurate due to host command skipping PI checks. By executing the compare command at high performance, without the addition of an additional storage (i.e., Temp Storage 2), efficient compare command execution occurs without increasing costs.

In one embodiment, a data storage device comprises: a memory device; and a controller coupled to the memory device, wherein the controller is configured to: receive a compare command; fetch encrypted data from the memory device, wherein the encrypted data is for the compare command; fetch not encrypted data from a host device, wherein the not encrypted data is for the compare command; encrypt the not encrypted data fetched from the host device; and compare the encrypted data fetched from the memory device and the encrypted data fetched from the host device. The controller is configured to decrypt a first logical block address (LBA) of the fetched encrypted data from the memory device. The controller is configured to extract protection information (PI) from the decrypted first LBA. The controller is configured to replace information in one or more PI fields of the not encrypted data fetched from the host device, wherein the replacing comprises inserting the extracted PI into the one or more PI fields. The encrypting comprises encrypting the data together with the inserted PI in the one or more PI fields. The controller is configured to determine that the compare command comprises one or more fields marked for not checking. The controller is configured to dynamically determine whether to execute compare commands using encrypted data or decrypted data. The controller is configured to determine a workload of a decryption module and perform the dynamic determining based upon the determined workload. The controller is configured to determine a workload of an encryption module and perform the dynamic determining based upon the determined workload. The controller is configured to determine that protection information (PI) in the not encrypted data fetched from the host device is inaccurate.

In another embodiment, a data storage device comprises: a memory device; and a controller coupled to the memory device, wherein the controller is configured to: receive a compare command; determine whether the compare command has protection information (PI) metadata; determine whether one or more PRCHK fields equal 0; fetch a first logical block address (LBA) from the memory device; decrypt the first LBA; extract PI from the decrypted first LBA and insert the extracted PI into PI fields of user data fetched from a host device; and execute the compare command using encrypted data. The first LBA is decrypted without sending the decrypted first LBA to the host device. The controller is configured to encrypt the user data, wherein the user data contains the extracted PI that was inserted into the PI fields. The controller is configured to read encrypted data from the memory device and store the encrypted data in a first storage location. The controller is configured to fill one or more Dwords within the compare command. The one or more Dwords are from the decrypted LBA. The controller is configured to dynamically determine whether to execute compare commands using encrypted data or decrypted data.

In another embodiment, a data storage device comprises: means for storing data; and a controller coupled to the means for storing data, wherein the controller is configured to: determine a workload of one or more of a decryption module and an encryption module; decide to execute compare commands using decrypted data or encrypted data based upon the determining; and execute compare commands based upon the deciding, wherein the determining and deciding are repeated. The controller is configured to determine when to execute the compare commands dynamically. The controller is configured to execute compare commands using encrypted data, wherein the encrypted data includes protection information (PI) encrypted with user data, wherein the PI is obtained from the means for storing data.

While the foregoing is directed to embodiments of the present disclosure, other and further embodiments of the disclosure may be devised without departing from the basic scope thereof, and the scope thereof is determined by the claims that follow.

1. A data storage device, comprising:
a memory device; and
a controller coupled to the memory device, wherein the controller is configured to:
receive a compare command;
fetch encrypted data from the memory device, wherein the encrypted data is for the compare command;
fetch not encrypted data from a host device, wherein the not encrypted data is for the compare command;
encrypt the not encrypted data fetched from the host device; and
compare the encrypted data fetched from the memory device and the encrypted data fetched from the host device.

2. The data storage device of claim 1, wherein the controller is configured to decrypt a first logical block address (LBA) of the fetched encrypted data from the memory device.

3. The data storage device of claim 2, wherein the controller is configured to extract protection information (PI) from the decrypted first LBA.

4. The data storage device of claim 3, wherein the controller is configured to replace information in one or more PI fields of the not encrypted data fetched from the host device, wherein the replacing comprises inserting the extracted PI into the one or more PI fields.

5. The data storage device of claim 4, wherein the encrypting comprises encrypting the data together with the inserted PI in the one or more PI fields.

6. The data storage device of claim 1, wherein the controller is configured to determine that the compare command comprises one or more fields marked for not checking.

7. The data storage device of claim 1, wherein the controller is configured to dynamically determine whether to execute compare commands using encrypted data or decrypted data.

8. The data storage device of claim 7, wherein the controller is configured to determine a workload of a decryption module and perform the dynamic determining based upon the determined workload.

9. The data storage device of claim 7, wherein the controller is configured to determine a workload of an encryption module and perform the dynamic determining based upon the determined workload.

10. The data storage device of claim 1, wherein the controller is configured to determine that protection information (PI) in the not encrypted data fetched from the host device is inaccurate.

11. A data storage device, comprising:
a memory device; and
a controller coupled to the memory device, wherein the controller is configured to:
receive a compare command;
determine whether the compare command has protection information (PI) metadata;
determine whether one or more PRCHK fields equal 0;
fetch a first logical block address (LBA) from the memory device;
decrypt the first LBA;
extract PI from the decrypted first LBA and insert the extracted PI into PI fields of user data fetched from a host device; and
execute the compare command using encrypted data.

12. The data storage device of claim 11, wherein the first LBA is decrypted without sending the decrypted first LBA to the host device.

13. The data storage device of claim 11, wherein the controller is configured to encrypt the user data, wherein the user data contains the extracted PI that was inserted into the PI fields.

14. The data storage device of claim 11, wherein the controller is configured to read encrypted data from the memory device and store the encrypted data in a first storage location.

15. The data storage device of claim 11, wherein the controller is configured to fill one or more Dwords within the compare command.

16. The data storage device of claim 15, wherein the one or more Dwords are from the decrypted LBA.

17. The data storage device of claim 11, wherein the controller is configured to dynamically determine whether to execute compare commands using encrypted data or decrypted data.

18. A data storage device, comprising:
means for storing data; and
a controller coupled to the means for storing data, wherein the controller is configured to:
determine a workload of one or more of a decryption module and an encryption module;
decide to execute compare commands using decrypted data or encrypted data based upon the determining; and
execute compare commands based upon the deciding, wherein the determining and deciding are repeated.

19. The data storage device of claim 18, wherein the controller is configured to determine when to execute the compare commands dynamically.

20. The data storage device of claim 18, wherein the controller is configured to execute compare commands using encrypted data, wherein the encrypted data includes protection information (PI) encrypted with user data, wherein the PI is obtained from the means for storing data.
